(19) United States
(12) Patent Application Publication
(10) Pub. No.: US 2023/0160418 A1
(43) Pub. Date: May 25, 2023

(54) WALL-MOUNTED HOLDER

(71) Applicant: ALPHA NETWORKS INC., Hsinchu (TW)

(72) Inventor: TZU-CHIH LIN, Hsinchu (TW)

(73) Assignee: ALPHA NETWORKS INC., Hsinchu (TW)

(21) Appl. No.: 17/703,776

(22) Filed: Mar. 24, 2022

(30) Foreign Application Priority Data
Nov. 25, 2021 (TW) 110143947

(51) Int. Cl. F16C 11/06; F16M 13/02

(52) U.S. Cl. CPC F16C 11/0695; F16M 13/02

(57) ABSTRACT

A wall-mounted holder is used to fix a photographic equipment to a wall. The wall-mounted holder includes a seat, a cover, and a connecting member. The seat is fixed to the wall. The cover is engaged with the seat in a manner that allows the cover to be movable along an axis relative to the seat. The connecting member has a ball joint that is clamped between the cover and the seat. The connecting member has a shaft that is connected to the ball joint. A part of the shaft protrudes out of the cover, so that the photographic equipment could be mounted to the shaft. Thus, by adjusting the swinging position of the shaft, a camera shot angle of the photographic equipment could be changed.

### BACKGROUND OF THE INVENTION

### Technical Field

The present invention relates generally to a fixing apparatus for fixing photographic equipment, and more particularly to a wall-mounted holder for fixing the photographic equipment to a wall of a building.

### Description of Related Art

Generally, photographic equipment for monitoring, such as a monitoring camera, is fixed to a wall of a building via a wall-mounted holder. There are many kinds of the wall-mounted holder, such as “Monitor supporter” of Taiwan utility model patent No. M251416. The monitor supporter consists of a base, a fixing seat, a connecting member with a ball head, a top cap, a knob, and a screw. A protruding seat is disposed at a middle of the base. The fixing seat is connected to the protruding seat via a screw. A middle section of the fixing seat is recessed to form a neck portion. The neck portion has a slanted surface at a top edge. The ball head of the connecting member abuts against a top end of the fixing seat. The ball head is connected to a screw. The top cap covers the connecting member. A knob is disposed at a side of the top cap. A screw of the knob protrudes into the neck portion of the fixing seat to abut against the slanted surface. When the knob is rotated to lock, the screw will move along the slanted surface to fix the neck portion of the fixing seat. Thus, the top cap could be engaged with the fixing seat. Simultaneously, the top cap is driven by the screw of the knob to move toward the base, thereby tightly engaging the fixing seat and the connecting member.

Since the monitor supporter has a lot of components, including the base, the fixing seat, the connecting member, the top cap, the knob, the screw, and so on, the assembly efficiency is reduced and the manufacturing cost is increased.

Additionally, the screw touches the slanted surface of the neck portion of the fixing seat via a “point”, which is a point contact. Therefore, when the knob is rotated to drive the screw to move toward the fixing seat, the neck portion of the fixing seat could be easily broken due to a small contact area of the point contact, resulting in the loose connection between the fixed seat and the ball joint and even permanent break to the monitor supporter. Additionally, the screw used to fasten the wall-mounted holder to the wall is exposed outside, which is not aesthetic.

### BRIEF SUMMARY OF THE INVENTION

In view of the above, the primary objective of the present invention is to provide a wall-mounted holder with a simplified structure (i.e. reducing the components thereof), which could still stably hold the photographic equipment.

The present inventive subject matter provides a seat, a cover, and a connecting member. The seat includes a base and a post, wherein the post is connected to the base and protrudes along an axis. A top end of the post constitutes a supporting portion. The cover includes a tube portion and a base portion, wherein the base portion is connected to a bottom end of the tube portion. The tube portion covers the post of the seat, the base portion is connected to the seat. An inner surface of a top end of the tube portion constitutes an abutting portion, and the top end of the tube portion has an opening. The connecting member includes a ball joint and a shaft, wherein the ball joint is located between the top end of the post of the seat and the top end of the tube portion of the cover. An end of the shaft is connected to the ball joint, and the other end of the shaft passes through the opening, which is adapted to be engaged with the photographic equipment.

With such design, when a force is exerted to rotate the seat, the cover could be rotated relative to the seat to drive the opening on the top portion of the cover to get close to the post of the seat. Therefore, the ball joint of the connecting member could be pushed to move toward the supporting portion of the seat, so that the ball joint of the connecting member could be stably mounted between the supporting portion of the seat and the abutting portion of the cover. The shaft of the connecting member passes through the opening on the tube portion of the cover, so that the photographic equipment could be fastened to the shaft.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the wall-mounted holder of a first embodiment according to the present invention;

FIG. 2 is an exploded view of the wall-mounted holder of the first embodiment according to the present invention;

FIG. 3 is a sectional view taken along the 3-3 line in FIG. 1;

FIG. 4 is a side view of the wall-mounted holder shown in FIG. 3, wherein the connecting member is moved;

FIG. 5 is a perspective view of the wall-mounted holder of a second embodiment of the present invention;

FIG. 6 is a section view taken along 6-6 line in FIG. 5;

FIG. 7 is a perspective view of the wall-mounted holder of a third embodiment of the present invention;

FIG. 8 is an exploded view of the wall-mounted holder of the third embodiment of the present invention; and,

FIG. 9 is a section view taken along 9-9 line in FIG. 7.

### DETAILED DESCRIPTION OF THE INVENTION

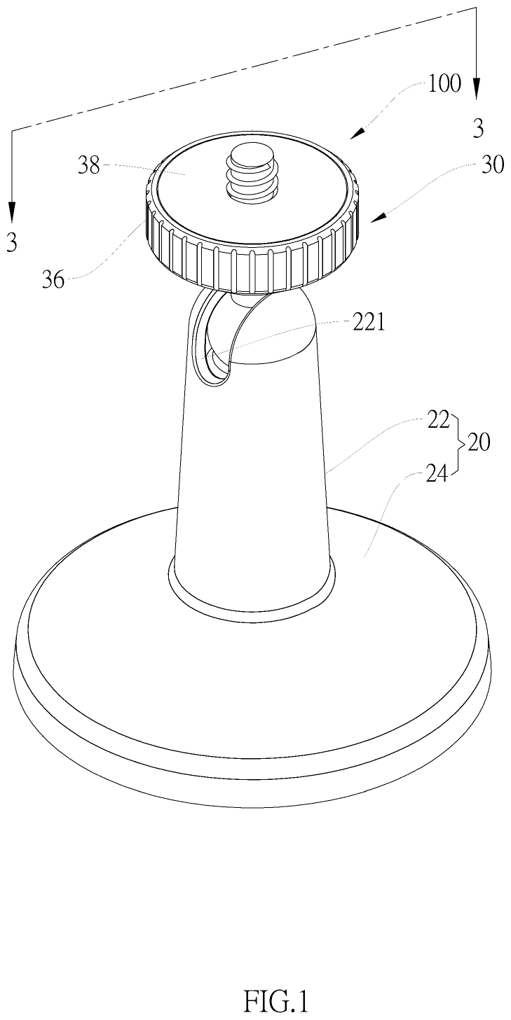

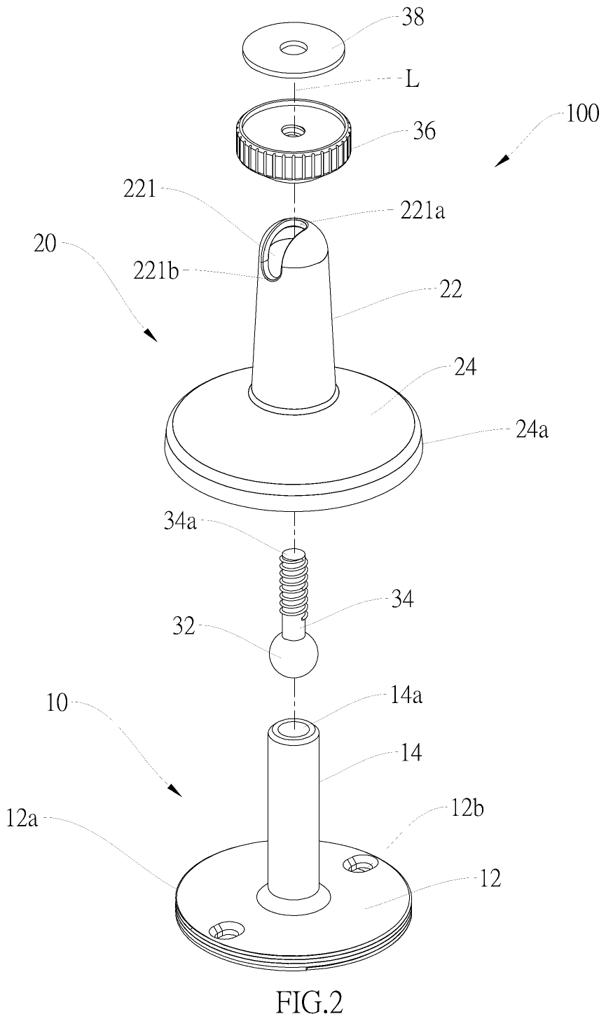

As illustrated in FIG. 1 to FIG. 4, a wall-mounted holder 100 of a first embodiment according to the present invention includes a seat 10, a cover 20, and a connecting member 30.

The seat 10 includes a base 12 and a post 14 that is connected to the base 12. In the current embodiment, the base 12 is disc-like and has a circumference 12a. An axis L is defined to pass through the base 12, wherein the post 14 is formed by protruding along the axis L. In the current embodiment, the axis L is perpendicular to the base 12, and the post 14 is integrally formed with the base 12 as a monolithic unit. The base 12 has a plurality of perforations 12b which are adapted to be passed through by fasteners (such as screws). The base 12 could be fixed to a wall of a building by using the fasteners. The post 14 has a top end that is opposite to an end connected to the base 12. The top end of the post 14 has a supporting portion 14a that is a concave surface formed by recessing into the top end of the post 14.

The cover 20 has a tube portion 22 and a base portion 24 which is connected to a bottom end of the tube portion 22. The tube portion 22 is a hollowed cone body and has a top end that is opposite to the bottom end. The base portion 24 is a disc body having an annular frame 24a. A bottom end of the tube portion 22 has an outer diameter that is greater than an outer diameter of the top end of the tube portion 22. The top end of the tube portion 22 is spherical and has an opening 221. In the current embodiment, the opening 221 is an elongated slot and has two closed ends 221a, 221b. An inner surface of the top end of the tube portion 22 constitutes an abutting portion 222. More specifically, the abutting portion 222 is constituted by an inner surface of a curved wall around the opening 221.

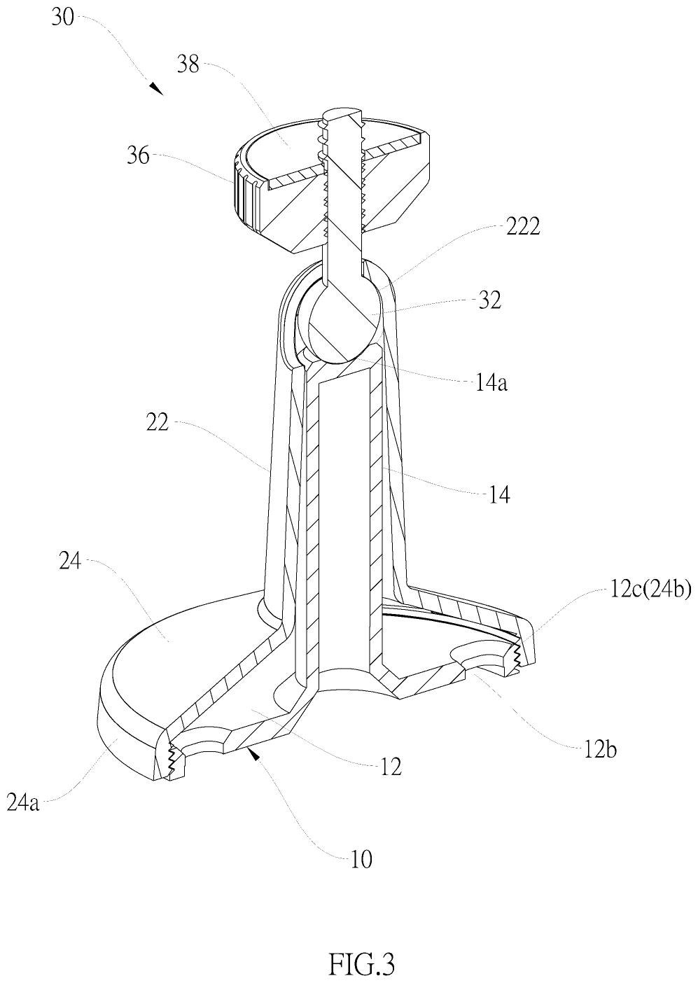

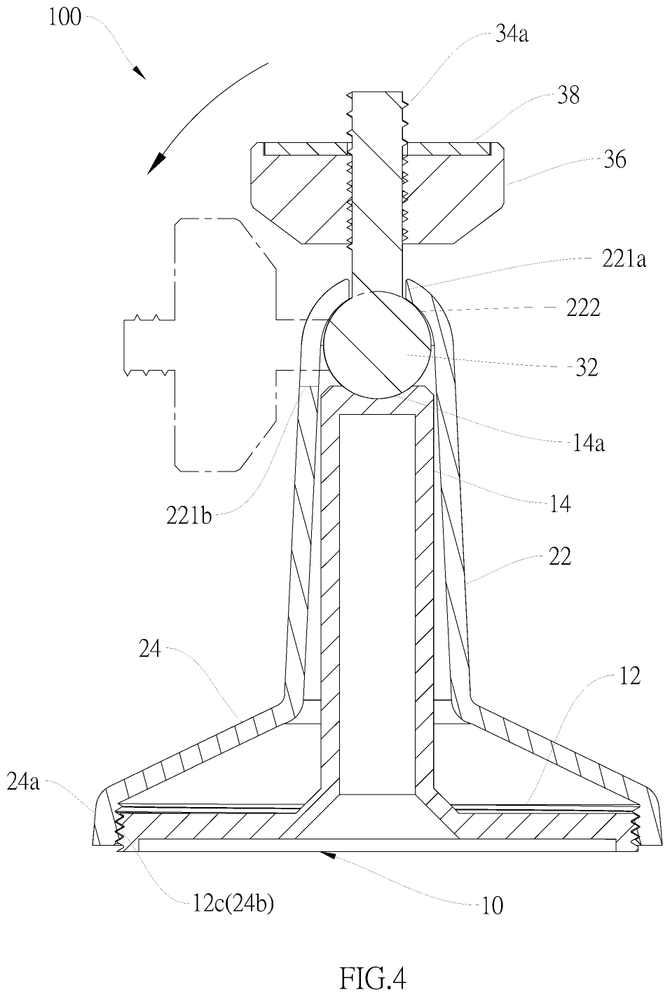

The connecting member 30 includes a ball joint 32 and a shaft 34. An end of the shaft 34 is connected to the ball joint 32, wherein the shaft 34 has a threading portion 34a. During an assembling process, a portion of the ball joint 32 abuts against the supporting portion 14a at the top end of the post 14 of the seat 10, and the cover 20 covers the seat 10 and the ball joint 32 to allow the shaft 34 to pass through the opening 221 of the cover 20. As illustrated in FIG. 3 and FIG. 4, more specifically, the tube portion 22 of the cover 20 fits around the post 14 of the seat 10, and the base portion 24 of the cover 20 covers the base 12 of the seat 10, so that the annular frame 24a of the base portion 24 circles around the circumference 12a of the base 12. The threading portion 34a of the shaft 34 passing through the cover 20 is adapted to be connected to photographic equipment (not shown).

When the seat 10 and cover 20 are engaged, the ball joint 32 is retained between the supporting portion 14a of the post 14 of the seat 10 and the abutting portion 222 of the tube portion 22 of the cover 20. Since the seat 10 and the cover 20 are tightly engaged, the abutting portion 222 of the cover 20 presses the ball joint 32 downward (namely toward the post 14), thereby allowing a part of a spherical surface of the ball joint 32 to tightly abut against the supporting portion 14a.

In the current embodiment, the seat 10 and the cover 20 are engaged by threading. The circumference 12a of the base 12 of the seat 10 is disposed with an external thread 12c, and an inner surface of the annular frame 24a of the base portion 24 of the cover 20 has an internal thread 24b. By simply engaging the internal thread 24b with the external thread 12c, the base portion 24 of the cover 20 could be engaged with the base 12 of the seat 10. Furthermore, by driving the cover 20 to rotate clockwise or counter-clockwise relative to the seat 10 that is fixed, a force exerted to the ball joint 32 by the cover 20 could be adjusted. When the force is great, the shaft 34 is hard to swing (namely, the swinging position of the shaft 34 could be fixed), so that the photographic equipment could be set at a predetermined camera angle to film or record. When the force is reduced, the swinging position of the shaft 34 could be adjusted easily. In the current embodiment, since the supporting portion 14a is a concave surface, the spherical surface of the ball joint 32 could be easily slid to adjust the swinging position of the shaft 34. Additionally, in the current embodiment, the opening 221 of the cover 20 is the slot with the two closed ends 221a, 221b, as shown in FIG. 4. The slot could guide the shaft 34 to swing in a predetermined direction, and the closed ends 221a, 221b of the slot could be abutted by the shaft 34.

It should be noted that except threading engagement, the seat 10 and the cover 20 could be engaged in other manners. For example, in another embodiment, the base 12 could be disposed with a fastening structure (e.g. protrusions), and the base portion 24 could be disposed with a corresponding fastening structure (e.g. hooks), so that the hooks of the base portion 24 could be hooked to the protrusions of the base 12 to tightly engage the seat 10 and the cover 20.

In order to stabilize the photographic equipment, a rotary plate 36 could be optionally disposed to the shaft 34, wherein the rotary plate 36 is threadedly connected to the shaft 34. A side of the rotary plate 36 is adapted to be abutted against by photographic equipment. Besides, an anti-slip cushion 38 could be mounted at the side of the rotary plate 36. After the photographic equipment is connected to the shaft 34, the anti-slip cushion 38 is disposed between the rotary plate 36 and the photographic equipment, thereby enhancing the stabilization of the photographic equipment.

The wall-mounted holder of other embodiments that could achieve the same objective are described below.

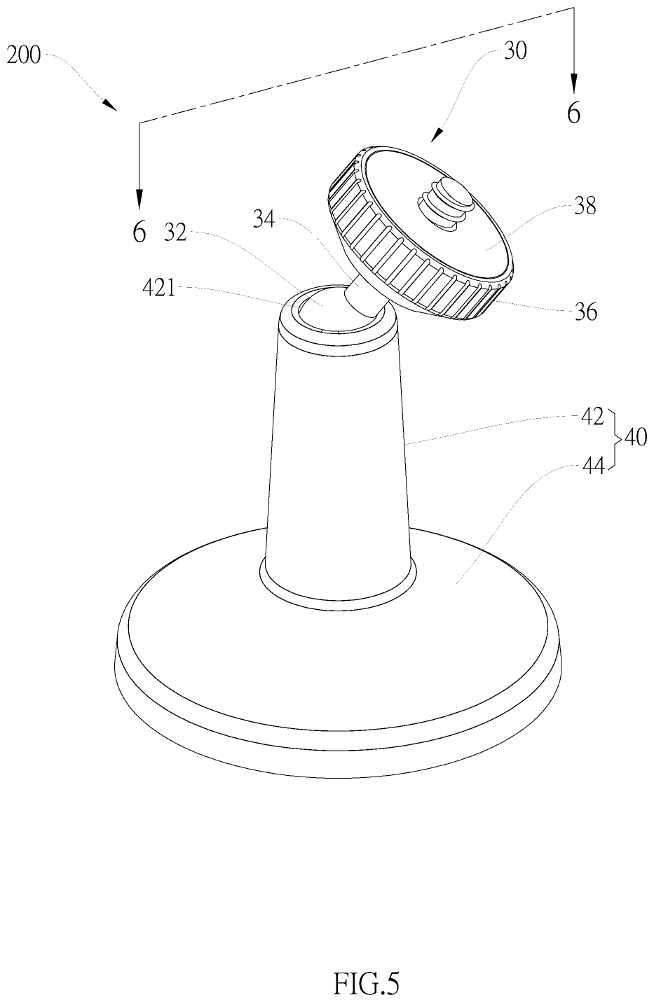

As illustrated in FIG. 5, the wall-mounted holder 200 of a second embodiment according to the present invention has almost the same structure as that of the first embodiment, except the cover. The following description only mentions the differences.

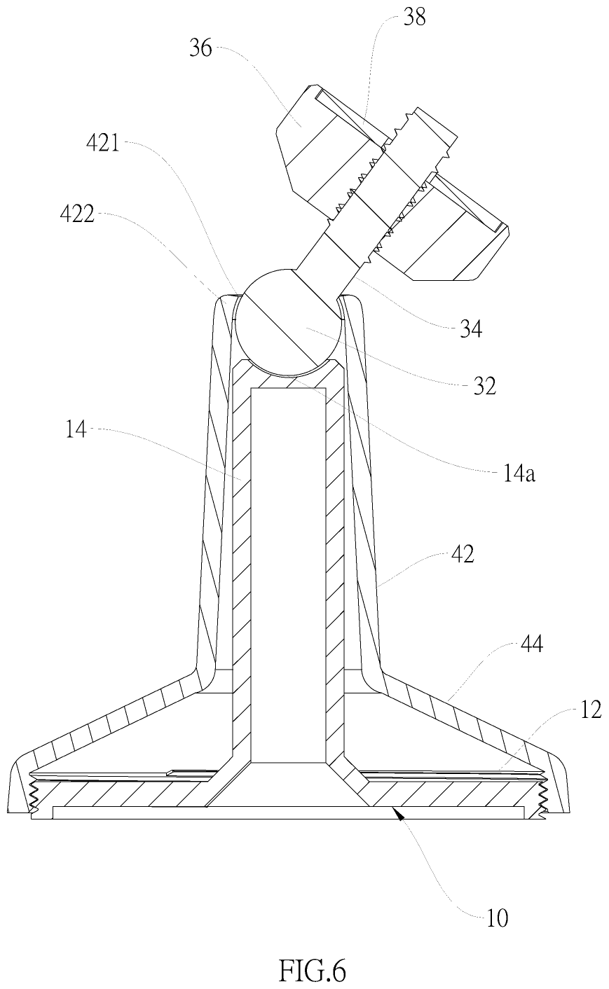

A cover 40 of the wall-mounted holder 200 of the second embodiment has a tube portion 42 and a base portion 44, wherein the base portion 44 is connected to a bottom end of the tube portion 42. The base portion 44 is engaged with the base 12 of the seat 10 in a manner of threading. A top end of the tube portion 42, which is opposite to the bottom end, has an opening 421, wherein the opening 421 is a circular hole. As illustrated in FIG. 6, an inner surface of the tube portion around the opening 421 constitutes an abutting portion 422. When the wall-mounted holder 200 is assembled completed, a top half portion of the spherical surface of the ball joint 32 of the connecting member 30 touches the abutting portion 422, and a bottom half portion of the spherical surface of the ball joint 32 touches the supporting portion 14a. Preferably, each of the abutting portion 422 and the supporting portion 14a is constituted by a curved surface. Similarly, by simply screwing the cover 40 in a clockwise direction or a counter-clockwise direction, the cover 40 could be moved up or down along the axis L relative to the seat 10, thereby pressing or releasing the ball joint 32 of the connecting member 30. Since the opening 421 of the wall-mounted holder 200 is circular, the shaft 34 of the connecting member 30 could be arbitrarily swung and adjusted within the circular hole, thereby enhancing the flexibility of adjustment.

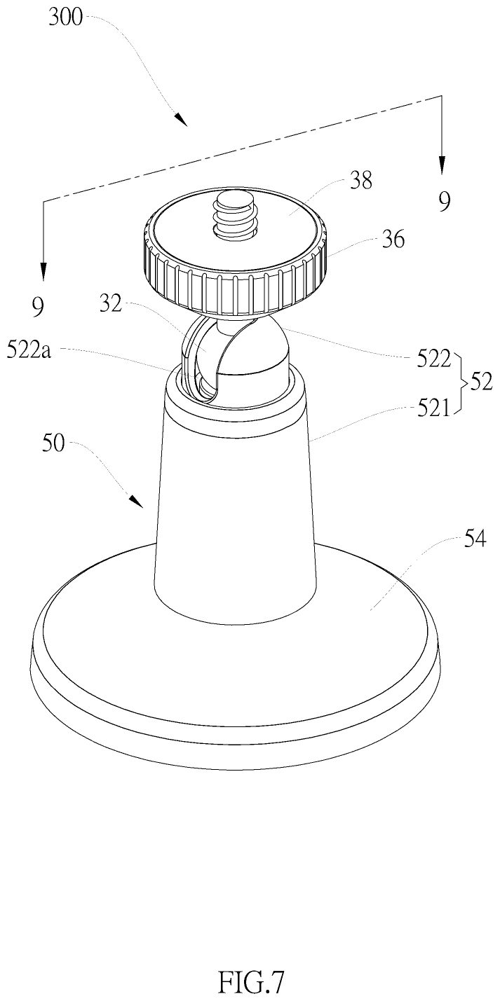

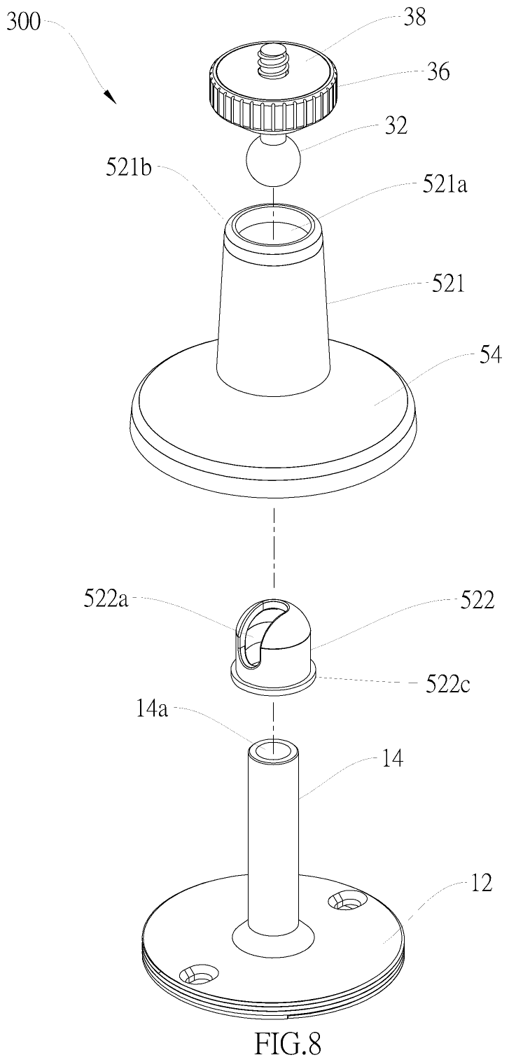

As illustrated to FIG. 7 to FIG. 9, the wall-mounted holder 300 of a third embodiment according to the present invention has almost the same structure as that of the first embodiment, except the cover. The following description only mentions the differences.

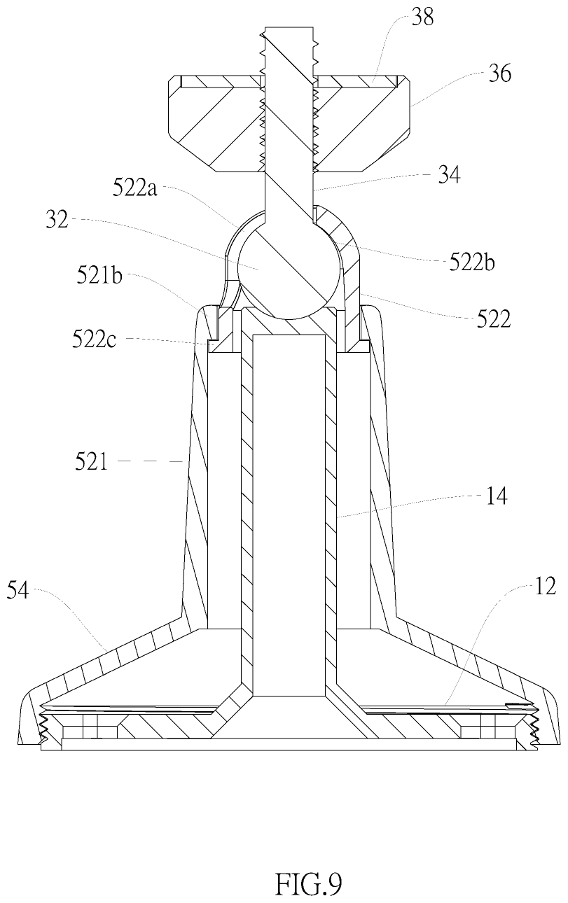

A cover 50 of the third embodiment has a tube portion 52 and a base portion 54 that is connected to a bottom end of the tube portion 52, wherein the tube portion 52 is constituted by a tube body 521 and a cap 522. A bottom end of the tube body 521 is connected to the base portion 54 that is constituted by a disc body. A top end of the tube body 521 has a circular hole 521a. The tube body 521 forms a blocking edge 521b around a circumference of the circular hole 521a. The cap 522 is approximately semispherical. The cap 522 has an opening 522a on top, wherein the opening 522a is an elongated slot. The inner surface of the cap 522 around the opening 522a constitutes an abutting portion 522b. The cap 522 has a flange 522c protruding outward in a radial direction at the bottom. As illustrated in FIG. 9, when the wall-mounted holder 300 of a third embodiment is assembled, the cap 522 is located in the tube body 521, and the flange 522c of the cap 522 abuts against the blocking edge 52 lb. Thus, the cap 522 is rotatably connected to the top end of the tube body 521, wherein the cap 522 could be rotated along the axis L. With such design, the shaft 34 of the connecting member 30 could not only be arbitrarily adjusted in any radial direction of the tube body 521, but also be swung along the elongated slot (namely the opening 522a) to change the swinging position.

It must be pointed out that the embodiment described above is only a preferred embodiments of the present invention. All equivalent structures which employ the concepts disclosed in this specification and the appended claims should fall within the scope of the present invention.

What is claimed is:

1. A wall-mounted holder for connecting to a photographic equipment, comprising:
a seat comprising a base and a post, wherein the post is connected to the base and protrudes along an axis; a top end of the post constitutes a supporting portion;
a cover comprising a tube portion and a base portion, wherein the base portion is connected to a bottom end of the tube portion; the tube portion covers the post of the seat, the base portion is connected to the seat; an inner surface of a top end of the tube portion constitutes an abutting portion, and the top end of the tube portion has an opening;
a connecting member comprising a ball joint and a shaft, wherein the ball joint is located between the top end of the post of the seat and the top end of the tube portion of the cover; an end of the shaft is connected to the ball joint, another end of the shaft passes through the opening, which is adapted to be engaged with the photographic equipment;
wherein, when the wall-mounted holder is assembled, the cover presses the ball joint down by the abutting portion to allow the ball joint tightly abutting against the supporting portion.

2. The wall-mounted holder as claimed in claim 1, wherein the base portion of the cover is threadedly connected to the seat.

3. The wall-mounted holder as claimed in claim 2, wherein the base of the seat has a circumference, and the circumference has an external thread; the base portion of the cover is a disc body having an annular frame; the disc body covers the base; an inner surface of the annular frame has an internal thread, wherein the internal thread is adapted to be engaged with the external thread on the circumference of the base.

4. The wall-mounted holder as claimed in claim 3, wherein the opening at the top end of the tube portion of the cover is an elongated slot, wherein the elongated slot has two ends; the supporting portion of the post of the seat is constituted by a curved surface; a spherical surface of the ball joint of the connecting member contacts with the curved surface, and the shaft passes through the elongated slot and is swingable between the two ends.

5. The wall-mounted holder as claimed in claim 3, wherein the opening at the top end of the tube body of the cover is a circular hole; a top half portion of a spherical surface of the ball joint of the connecting member touches the abutting portion, and a bottom half portion of the spherical surface of the ball joint touches the supporting portion, wherein each of abutting portion and supporting portion is constituted by a curved surface.

6. The wall-mounted holder as claimed in claim 3, wherein the tube portion of the cover comprises a tube body and a cap; a bottom end of the tube body is connected to the disc body; the cap is rotatably connected to a top end of the tube body and is rotatable about the axis, the cap has the opening and the abutting portion.

7. The wall-mounted holder as claimed in claim 1, wherein the connecting member comprises a rotary plate, wherein the rotary plate is threadedly connected to the shaft.

8. The wall-mounted holder as claimed in claim 7, wherein the connecting member comprises an anti-slip cushion, the anti-slip cushion is disposed at a side of the rotary plate.
